(19) United States
(12) Patent Application Publication
(10) Pub. No.: US 2022/0380583 A1
(43) Pub. Date: Dec. 1, 2022

(54) MACHINABLE WAX WITH PLASTIC ADDITIVE AND METHOD OF MANUFACTURE

(71) Applicants: Rachel PRATO, Holland, PA (US); Anthony PRATO, Holland, PA (US)

(72) Inventors: Rachel PRATO, Holland, PA (US); Anthony PRATO, Holland, PA (US)

(21) Appl. No.: 17/752,695

(22) Filed: May 24, 2022

Related U.S. Application Data
(60) Provisional application No. 63/193,001, filed on May 25, 2021.

(51) Int. Cl. C08L 23/06; C08L 91/06; C08J 3/20; C08J 3/00; B29C 67/24

(52) U.S. Cl. CPC C08L 23/06; C08L 91/06; C08J 3/203; C08J 3/005; B29C 67/241; C08L 2207/066; C08L 2205/06; C08L 2205/035; C08L 2205/025; C08J 2323/06; C08J 2391/06; C08J 2491/08

(57) ABSTRACT

A machinable wax with plastic additive and method of manufacture is shown and described. The machinable wax with a plastic additive includes between twenty-five (25) percent and thirty-five (35) percent of the polyethylene (PE) Wax by volume. The machinable wax includes between thirty-five (35) percent and forty-five (45) percent of LD polyethylene by volume. The machinable wax also includes between ten (10) percent and twenty (20) percent of micro crystalline wax by volume and between seven (7) percent and twelve (12) percent of paraffin wax by volume. In some embodiments the machinable wax includes between three (3) percent and six (6) percent of acetic acid ethenyl ester by volume. In some instances, the machinable wax has less than or equal to one (1) percent of colorant by volume added.

### CROSS REFERENCE TO RELATED APPLICATIONS

This application claims the benefit of U.S. Provisional Application No. 63/319,001 filed on May 25, 2021. The above identified patent application is herein incorporated by reference in its entirety to provide continuity of disclosure.

### BACKGROUND OF THE INVENTION

The present invention relates to machinable wax. More particularly, the present invention provides a machinable wax including a plastic additive.

Machinable wax is often used within different industries as a means to create prototypes or products. Machinable wax is supposed to be a relatively inexpensive and easy to work with material. Machinable wax is also supposed to allow for easy prototyping or other product creation. However, the current industry standard for machinable wax is severely lacking in several areas.

First, while machinable wax is considered an inexpensive material and it is typically created from various mixtures of wax-based products. These wax-based products are in fact extremely pricy compared to other potential material additives. Second, machinable waxes are typically softer materials. There is currently no way to achieve both high impact resistance and flexibility which are desired mechanical traits using the current industry standard.

Second, current machinable wax tends to be brittle. The current heating and cooling processes required to make machinable wax leaves much to be desired. These processes leave air bubbles and poorly coupled materials as a result of this process. It is difficult to predict if a given block of wax will hold up as needed or have a fatal flaw therein. This problem is a result of the different melting points of various materials. The problem is compounded if other products are added into the machinable wax. This draw back severely limits the make-up of current machinable waxes.

Consequently, there is a need for an improvement in the art of machinable wax. The present invention substantially diverges in design elements from the known art while at the same time solves a problem many people face when looking for cost effective machinable waxes which still maintains the desired quality of product. In this regard the present invention substantially fulfills these needs.

### SUMMARY OF THE INVENTION

The present invention provides a machinable wax with plastic additive and method for manufacture wherein the same can be utilized for providing convenience for a user when using machinable wax with a desire for characteristics currently not available in the industry. The method of manufacturing the machinable wax with a plastic additive begins by adding wax components to a mixing reactor. Then heating the wax components to a desired temperature. Once the desired temperature is reached the wax components are mixed together. Various gases may be released during the mixing process and must be removed from the mixture of wax components. The machinable wax must then be cooled.

Another object of the method for manufacturing machinable wax with a plastic additive is to have the wax components include at least polyethylene and a wax material

Another object of the method for manufacturing machinable wax with a plastic additive is to have the wax material is at least one selected from the group consisting of polyethylene (PE) wax, micro crystalline wax, and paraffin wax.

Another object of the method for manufacturing machinable wax with a plastic additive is to have the wax components further include an acetic acid ethenyl ester.

Another object of the method for manufacturing machinable wax with a plastic additive is to have the wax components further include a colorant.

Another object of the method for manufacturing machinable wax with a plastic additive is to have the wax components include polyethylene (PE) wax, LD polyethylene, micro crystalline wax and paraffin.

Another object of the method for manufacturing machinable wax with a plastic additive is to have the polyethylene (PE) wax make up between twenty-five (25) percent and thirty-five (35) percent of the machinable wax by volume.

Another object of the method for manufacturing machinable wax with a plastic additive is to have the LD polyethylene make up between thirty-five (35) percent and forty-five (45) percent of the machinable wax by volume.

Another object of the method for manufacturing machinable wax with a plastic additive is to have the micro crystalline wax make up between ten (10) percent and twenty (20) percent of the machinable wax by volume.

Another object of the method for manufacturing machinable wax with a plastic additive is to have the paraffin wax make up between seven (7) percent and twelve (12) percent of the machinable wax by volume.

Another object of the method for manufacturing machinable wax with a plastic additive is to have the acetic acid ethenyl ester make up between three (3) percent and six (6) percent of the machinable wax by volume.

Another object of the method for manufacturing machinable wax with a plastic additive is to have the colorant make up less than or equal to one (1) percent of the machinable wax by volume.

Another object of the method for manufacturing machinable wax with a plastic additive is to have the wax components heated to at least three hundred (300) degrees.

Another object of the method for manufacturing machinable wax with a plastic additive is to have the process of degassing the mixture which is comprising of the following steps: cooling the mixture of wax components to a temperature less than three hundred (300) degrees but higher than the melting point of the component which the highest melting point. Then the wax components are placed in a vacuum. Then waiting for a predetermined amount of time for gas to exit the mixture of wax components.

Another object of the method for manufacturing machinable wax with a plastic additive is to have sonication used as the process of degassing the mixture.

Another object of the method for manufacturing machinable wax with a plastic additive is to form the wax components into a desired shape.

Another object of the method for manufacturing machinable wax with a plastic additive is to have heat applied to the exterior of the machinable wax.

Another object of the method for manufacturing machinable wax with a plastic additive is to have the heat applied to the exterior for a predetermined time and of a temperature that will allow the exterior of the machinable wax to cool at the same rate as the interior of the machinable wax.

Another object of the method for manufacturing machinable wax with a plastic additive is to have the application of the heat is done using a heated table; and wherein the heated table will appropriately reduce the heat applied to the machinable wax.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flow chart of an embodiment of a method for manufacturing machinable wax including associated structural components.

FIG. 2 shows a chart of an embodiment of a mixture for machinable wax.

FIG. 3 shows a perspective view of several embodiments of machinable wax structures.

### LIST OF REFERENCE NUMERALS

With regard to the reference numerals used, the following numbering is used throughout the drawings.
101 Wax components
102 Batch reactor
102A Manual temperature input
102B Temperature sensor
102C Heating element
102D Proportional control
102E Integral control
102F Derivative control
102G Mixer
102H Mixer speed control
103 Heating components
104 Components are mixed
105 Degasification process
106 Cooling process
107 Cooling table
107A Temperature sensor
1076 Heating element
107C User inputs
107D Automatic Processing
107E Process control step time
107F Temperature step
107G Proportional controller
107H Integral controller
107I Derivative controller
201 Polyethylene (PE) wax
   Low density (LD)
202 polyethylene
203 Micro crystalline wax
204 Paraffin wax
205 Acetic acid ethynyl ester
206 Colorant
207 Example columns
208 Example columns
301 Puck
302 Puck
303 Brick
303a Material make up of brick
304 Cylinder

### DETAILED DESCRIPTION OF THE INVENTION

Reference is made herein to the attached drawings. Like reference numerals are used throughout the drawings to depict like or similar elements of the machinable wax with plastic additive and method for manufacture. For the purposes of presenting a brief and clear description of the present invention, a preferred embodiment will be discussed as used for the machinable wax with plastic additive and method for manufacture. The figures are intended for representative purposes only and should not be considered to be limiting in any respect.

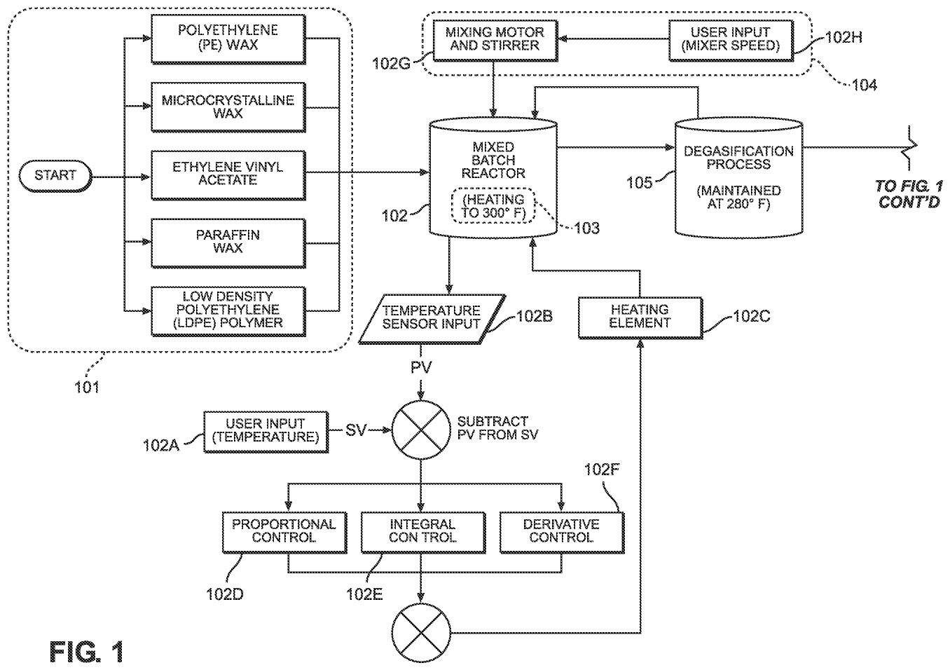

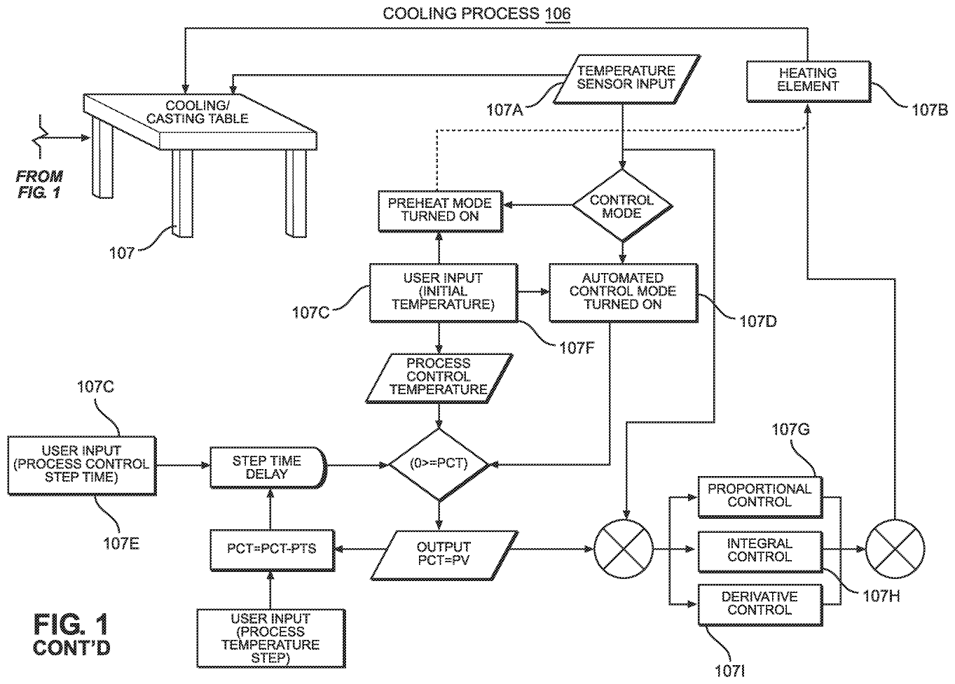

Referring now to FIG. 1, there is shown flow chart of an embodiment of a method for manufacturing machinable wax including associated structural components. The method starts by measuring out the necessary wax components 101. In the shown embodiment there are five (5) wax components which will be added to the machinable wax. In other embodiments varying amounts of wax components may be used to achieve the same desired result.

In one embodiment the wax components are added to a batch reactor 102. The batch reactor 102 will give the user desired controls to enable proper mixing of the wax components. After the components are added to the batch reactor 102, they must be heated to an appropriate temperature such that the wax components melt 103. It is necessary that the wax components are brought to a temperature which is at least equal to the highest melting point of the wax components. In one embodiment a temperature of 300 degrees will ensure that all of the wax components melt.

In one embodiment the batch reactor 102 includes components to facilitate the heating 103. In one embodiment the batch reactor 102 includes a manual temperature input 102A, a temperature sensor 102B, and a heating element 102C. Using these components will allow for the batch reactor to be brought to the desired temperature. In another embodiment, in order to provide a more specific temperature, the batch reactor 102 includes additional components. In this embodiment a proportional control 102D, an integral control 102E, and a derivative control 102F are added to the batch reactor 102. These controls will allow for a more specific temperature control.

After the wax components are properly melted, they are mixed 104. The mixing process ensures that the wax components are properly combined. In one embodiment the batch reactor 102 supports the mixing of the melted wax components. In one embodiment the batch reactor 102 includes a mixer 102G, and a mixer speed control 102H. This will ensure that a user can adjust the mixer to properly mix the wax components.

When mixing the wax components, it is likely that various gas bubbles will enter the mixture. If the mixture was allowed to cool and harden with the gas bubbles encapsulated therein the cooled wax could become brittle or have a pocket left therein. This could cause the wax to be useless when it comes to forming the wax. In order to solve the issue of gas bubbles in the mixture a degasification process is completed 105.

In one embodiment the degasification process 105 begins by allowing the temperature of the wax mixture to cool slightly. In one embodiment the wax mixture is allowed to cool to 280 degrees. In different embodiments different temperatures may be used. It is important that the wax mixture stays in a liquid form.

In one embodiment once the wax mixture is cooled the mixture is degassed utilizing sonication. In another embodiment the degassing process involves putting the mixture in a vacuum. The combination of degassing and the cooling allows for the viscosity of the wax mixture to be lessened. Further, the degassing will cause the gas bubbles within the wax mixture to form through cavitation. Once the gas bubbles form, they will expand and rise to the surface of the wax mixture and thereby exit the mixture.

After the gasses are removed from the wax mixture the mixture must be cooled 106. In one embodiment after the degassing process 105 has been completed the wax is poured into molds, this will produce a desired shape. In one embodiment the cooling process 106 ends once the wax mixture is poured into molds. However, if the machinable wax is left to cool naturally, the exterior of the wax will cool much faster than the interior. Cooling in this way can thus lead to a weaker end product.

As the machinable wax cools it is prone to a certain amount of expected shrinkage. This shrinkage is between 4% and 7%. If the machinable wax does not cool evenly the shrinkage could result in internal mechanical stresses. In some instances, cracks could form in the material. In a worse case the cracks would not show until the machinable wax is put to use.

In order to prevent the weakening and/or cracking of the machinable wax in one embodiment the cooling process 106 uses a heating machine to allow the exterior of the machinable wax to cool at the same rate as the interior of the machinable wax. In one embodiment a cooling table 107 is used to conduct the cooling process 106. Heat from the cooling table 107 will incrementally decrease as the temperature of the interior of the machinable wax cools.

In order to best effectuate the cooling process 106 specialized machinery may be used such as the previously referenced cooling table 107. In one embodiment the cooling table 107 includes a temperature sensor 107A and a heating element 107B. The temperature sensor 107A and the heating element 107B are connected together and will adjust the temperature of the cooling table 107 in order to properly cool the machinable wax.

In another embodiment the temperature sensor 107A and the heating element 107B are connected together with various other components. In one embodiment these components allow for user inputs 107C and automatic processing 107D. The user inputs 107C will allow for the cooling table to automatically step down the temperature at set time intervals to ensure proper cooling.

After the user inputs a “process control step time” 107E and a “process temperature step” 107F the system will then automatically control the temperature of the cooling table 107. In one embodiment the temperature is controlled by a proportional controller 107G, an integral controller 107H, and a derivative controller 107I. The various controllers are connected to and control the heating element for proper cooling.

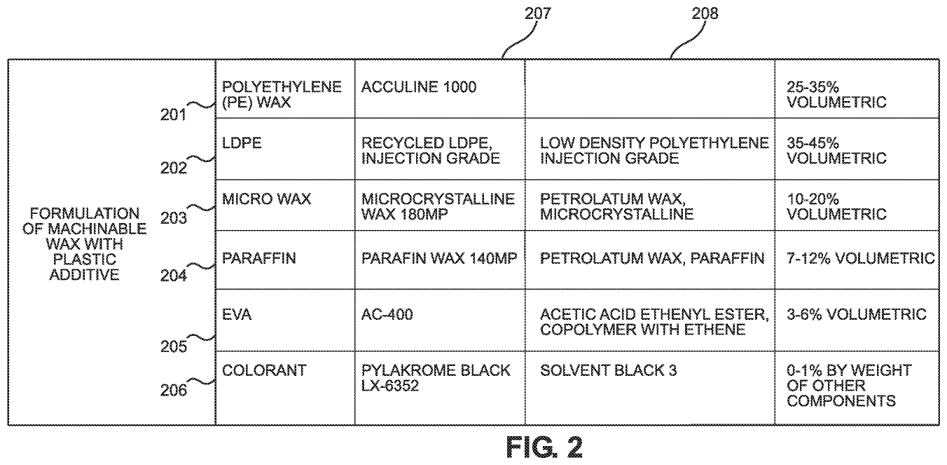

Referring now to FIG. 2, there is shown a chart of an embodiment of a mixture for machinable wax. In various embodiments different percentages of materials are used to create the final machinable wax mixture. It is to be understood that as part of this disclosure that modifications of one or more ingredients outside of the shown ranges could still produce substantially similar results.

In the shown embodiment the materials include polyethylene (PE) wax 201, low density (LD) polyethylene 202, micro crystalline wax 203, paraffin wax 204, acetic acid ethenyl ester 205, and a colorant 206. In various embodiments different percentages of each material are used. In one embodiment between 25% and 35% percent of the machinable wax is polyethylene (PE) wax 201. In one embodiment the machinable wax includes between 10% and 20% microcrystalline wax 203. In a further embodiment the machinable wax includes between 7% and 12% of paraffin wax 204. In one embodiment the machinable wax includes between 3% and 6% acetic acid ethenyl ester 205.

The machinable wax also includes a plastic additive. In some embodiments new or virgin plastics are used to create the machinable wax. In other embodiments a recycled plastic is used to create the wax. In one embodiment at least forty (40%) percent of the machinable wax is made from recycled plastics. The use of plastic reduces cost since plastic is roughly ten (10) times less expensive than wax by weight. In one embodiment the machinable wax includes between 35% and 45% of low-density (LD) polyethylene 202. The use of this LD polyethylene will achieve the above cost effects. Further, the use of low-density polyethylene 202 will ensure a flexible and strong end result.

In various embodiments a colorant 206 is added to the machinable wax mixture. In one embodiment a black colorant 206 is used. In other embodiments different colors may be used for different purposes or needs. In various embodiments various colors may be used as desired.

For the purposes of this chart, it is important to understand the materials in columns 207 and 208 are for example purposes. One of ordinary skill in the art will understand that many different materials may be used to achieve the desired effects. For example, the machinable wax with plastic additive may be desired in a color other than black.

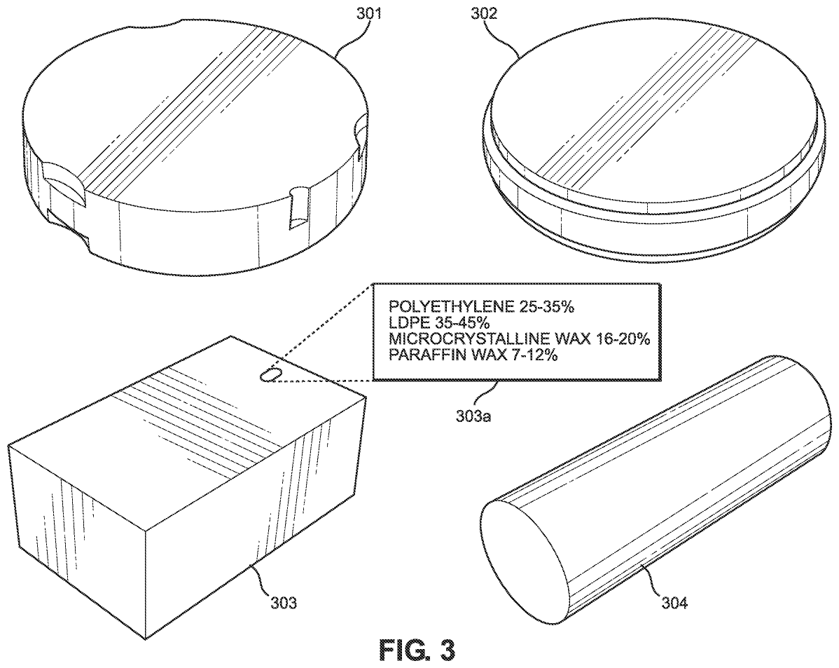

Referring now to FIG. 3, there is shown a perspective view of several embodiments of machinable wax structures. FIG. 3 shows several different possible shapes for which the machinable wax with a plastic additive may be shaped into.

In several embodiments the machinable wax with plastic additive can be formed into pucks 301, 302. These pucks 301, 302 may have different characteristics. For example, puck 302 includes an indent around the edge on both sides of the puck 302. In one embodiment these pucks 301, 302 are ready for use in dental practice. In other embodiments the pucks 301, 302 can be used for various needs.

In another embodiment the machinable wax with a plastic additive is formed into a brick 303. In this FIG. the call out 303a shows the material make-up of the wax brick 303. A brick may be used in order to machine into various needed forms. The structure of the machinable wax with a plastic additive is such that many different forms may be machined from a brick of the wax while maintaining structural integrity.

In yet a further embodiment a cylinder 304 is made from the machinable wax with plastic additive. In one embodiment the cylinder 304 is the starting place to machine the pucks 301, 302. In yet another embodiment the cylinder 304 similar to the brick 303 will allow for many forms to be machined therefrom.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for manufacturing machinable wax with a plastic additive, the method comprises:
adding wax components to a mixing reactor, where in the wax components are comprised of at least one wax and at least one plastic;
heating the wax components to a desired temperature;
mixing the wax components;
degassing the mixture of wax components;
cooling the wax components.

2. The method for manufacturing machinable wax with a plastic additive of claim 1, wherein the wax components are comprised of at least LD polyethylene and a wax material.

3. The method for manufacturing machinable wax with a plastic additive of claim 2, wherein the wax material is at least one selected from the group consisting of polyethylene (PE) wax, Micro crystalline wax, and paraffin wax.

4. The method for manufacturing machinable wax with a plastic additive of claim 2, wherein the wax components are further comprised of an acetic acid ethenyl ester.

5. The method for manufacturing machinable wax with a plastic additive of claim 2, wherein the wax components are further comprised of a colorant.

6. The method for manufacturing machinable wax with a plastic additive of claim 1, wherein the wax components are comprised of polyethylene (PE) wax, Micro crystalline wax, and paraffin wax.

7. The method for manufacturing machinable wax with a plastic additive of claim 6, wherein the polyethylene (PE) wax makes up between twenty-five (25) percent and thirty-five (35) percent of the machinable wax by volume;
the LD polyethylene makes up between thirty-five (35) percent and forty-five (45) percent of the machinable wax by volume;
the micro crystalline wax makes up between ten (10) percent and twenty (20) percent of the machinable wax by volume; and
the paraffin wax makes up between seven (7) percent and twelve (12) percent of the machinable wax by volume.

8. The method for manufacturing machinable wax with a plastic additive of claim 4, wherein the acetic acid ethenyl ester makes up between three (3) percent and six (6) percent of the machinable wax by volume.

9. The method for manufacturing machinable wax with a plastic additive of claim 5, wherein the colorant makes up less than or equal to one (1) percent of the machinable wax by volume.

10. The method for manufacturing machinable wax with a plastic additive of claim 1, wherein the wax components are heated to at least three hundred (300) degrees Fahrenheit.

11. The method for manufacturing machinable wax with a plastic additive of claim 1, wherein degassing the mixture is comprising of the steps of:
cooling the mixture of wax components to a temperature less than three hundred (300) degrees Fahrenheit but higher than the melting point of the component which the highest melting point;
beginning a sonication process; and
waiting for a predetermined amount of time for gas to exit the mixture of wax components.

12. The method for manufacturing machinable wax with a plastic additive of claim 1 further comprising: forming the wax components into a desired shape.

13. The method for manufacturing machinable wax with a plastic additive of claim 1, wherein the cooling step is further comprised of:
applying heat to the exterior of the machinable wax.

14. The method for manufacturing machinable wax with a plastic additive of claim 13, wherein the heating applied to the exterior is applied for a time and of a temperature that will allow the exterior of the machinable wax to cool at the same rate as the interior of the machinable wax.

15. The method for manufacturing machinable wax with a plastic additive of claim 13, wherein the application of the heat is done using a heated table; and wherein the heated table will appropriately reduce the heat applied to the machinable wax.

16. A machinable wax with a plastic additive, the machinable wax is comprised of:
between twenty-five (25) percent and thirty-five (35) percent of the polyethylene (PE) wax by volume;
between thirty-five (35) percent and forty-five (45) percent of polyethylene by volume;
between ten (10) percent and twenty (20) percent of micro crystalline wax the machinable wax by volume; and
between seven (7) percent and twelve (12) percent of paraffin wax by volume.

17. The machinable wax with a plastic additive of claim 16 further comprising:
between three (3) percent and six (6) percent of acetic acid ethenyl ester by volume.

18. The machinable wax with a plastic additive of claim 16 further comprising:
less than or equal to one (1) percent of colorant by volume.

19. The machinable wax with a plastic additive of claim 17 further comprising:
less than or equal to one (1) percent of colorant by volume.

20. A machinable wax with a plastic additive, the machinable wax consists of:
between twenty-five (25) percent and thirty-five (35) percent of the polyethylene (PE) wax by volume;
between thirty-five (35) percent and forty-five (45) percent of LD polyethylene by volume;
between ten (10) percent and twenty (20) percent of micro crystalline wax the machinable wax by volume; and
between seven (7) percent and twelve (12) percent of paraffin wax by volume.
